(19) United States
(12) Patent Application Publication
(10) Pub. No.: US 2025/0342730 A1
(43) Pub. Date: Nov. 6, 2025

(54) INFORMATION PROCESSING DEVICE, CONTROL METHOD FOR INFORMATION PROCESSING DEVICE, AND STORAGE MEDIUM

(71) Applicant: CANON KABUSHIKI KAISHA, Tokyo (JP)

(72) Inventors: Atsuo NOMOTO, Tokyo (JP); Kazuhiko KOBAYASHI, Kanagawa (JP)

(21) Appl. No.: 19/270,551

(22) Filed: Jul. 16, 2025

Related U.S. Application Data
(63) Continuation of application No. PCT/JP2023/045115, filed on Dec. 15, 2023.

(30) Foreign Application Priority Data
Jan. 31, 2023 (JP) 2023-013523

(51) Int. Cl. G07C 5/00; G01C 21/34; G07C 5/08; H04W 4/029

(52) U.S. Cl. CPC G07C 5/008; G01C 21/3415; G07C 5/085; H04W 4/029

(57) ABSTRACT

Provided is an information processing device that can improve post-accident processing, which includes an event information reception unit configured to receive event information of an event that occurs in an autonomous movable apparatus; and a device information acquisition unit configured to acquire device information of a device other than the movable apparatus in which the event has occurred; and a post-processing unit configured to perform post-processing after the event has occurred based on the event information and device information.

### CROSS-REFERENCE TO RELATED APPLICATIONS

This application is a Continuation of International Patent Application No. PCT/JP2023/045115, filed Dec. 15, 2023, which claims the benefit of Japanese Patent Application No. 2023-013523, filed Jan. 31, 2023, both of which are hereby incorporated by reference herein in their entirety.

### BACKGROUND

### Field of Technology

The present disclosure relates to an information processing device, a control method for an information processing device, and a storage medium.

### Description of Related Art

There is a known technology for autonomous movable apparatuses, such as autonomous mobile robots, that move autonomously and perform tasks in various locations, such as office buildings, homes, and logistics centers. Such self-driving movable apparatuses use sensors to measure a distance to each object in the vicinity, scan a space as a map, such as point cloud data or a collection of feature points, and move autonomously.

On the other hand, when a movable apparatus has an accident, it is necessary to carry out post-processing such as accident recovery and recording. For movable apparatuses such as vehicles with drivers, the post-accident processing can be carried out manually, but for self-driving movable apparatuses, the movable apparatus itself needs to perform the post-processing to a certain extent automatically.

Japanese Patent Laid-Open No. 2008-124648 discloses a method of automatically transmitting video footage from a drive recorder installed in a vehicle to a specific facility when the vehicle detects an impact. Japanese Patent Laid-Open No. 2015-109025 discloses a method of detecting accidents from video footage collected from multiple movable apparatuses and reflecting the accident information on a map.

However, while the method of Japanese Patent Laid-Open No. 2008-124648 can transmit video footage in response to the occurrence of an accident, it can only perform uniform processing regardless of the type and scale of the accident or the status of the movable apparatus. Therefore, it is impossible to make post-accident responses according to the circumstances of the accident, such as setting an avoidance route depending on the accident location.

Furthermore, in the method of Japanese Patent Laid-Open No. 2015-109025, although accident information is shared, the setting and selection of avoidance routes must be done manually. In an environment where multiple autonomous movable apparatuses are operating, such manual operations are inconvenient.

For the conventional technologies, there is room for improvement in how accidents are dealt with thereafter.

### SUMMARY

An information processing device according to one embodiment of the present disclosure includes an event information reception unit configured to receive event information of an event that occurs in an autonomous movable apparatus; and a device information acquisition unit configured to acquire device information of a device other than the movable apparatus in which the event has occurred; and a post-processing unit configured to perform post-processing after the event has occurred based on the event information and device information.

Features of the present disclosure will become apparent from the following description of embodiments with reference to the attached drawings.

### BRIEF DESCRIPTION OF THE DRAWINGS

FIG. 1 is a diagram illustrating one example of a hardware configuration of a system including an information processing device according to an embodiment of the present disclosure.

FIG. 2 is a block diagram illustrating one example of a functional configuration of an information processing device 3 according to a first embodiment of the present disclosure.

FIG. 3 is a block diagram illustrating one example of a functional configuration of a movable apparatus 4 according to the first embodiment of the present disclosure.

FIG. 4 is a diagram illustrating a processing flow for receiving event information and performing post-processing according to the first embodiment of the present disclosure.

FIG. 5 is a diagram illustrating a processing flow illustrating details of post-event processing according to the first embodiment of the present disclosure.

FIG. 6 is a diagram illustrating a processing flow of a movable apparatus that transmits detected event information according to the first embodiment of the present disclosure.

FIG. 7 is a block diagram illustrating one example of a functional configuration of a server 1 according to a second embodiment of the present disclosure.

FIG. 8 is a diagram illustrating a processing flow illustrating details of post-event processing according to the second embodiment of the present disclosure.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

A first embodiment of the present disclosure will be described below. In the first embodiment, an example will be described in which a movable apparatus that is traveling autonomously detects a collision accident that it has caused, and transmits that information directly to another device, thereby allowing an information processing device to make post-accident response after it has occurred.

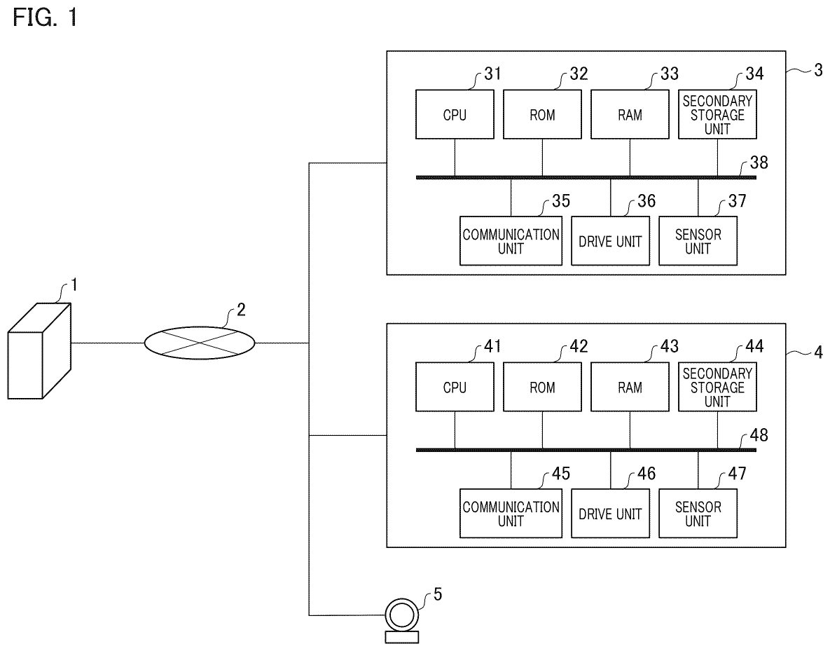

FIG. 1 is a diagram illustrating one example of a hardware configuration of a system including an information processing device according to a first embodiment of the present disclosure. As shown in FIG. 1, the system includes a server 1, a network 2, an information processing device 3, a movable apparatus 4, and a surveillance camera 5.

The server 1 controls and manages the entire system and is a general-purpose computer equipped with an arithmetic unit, storage device, and communication device. The server 1 also stores map data used by each movable apparatus included in the system and provides map data to each movable apparatus.

The server 1 also stores and manages information such as how many and what types of devices are operating within the system, and the driving plan for each movable apparatus. The server 1 is also connected to other devices via the network 2, can transmit and receive control signals and data.

The network 2 is a local area network used for communication between devices. Other communication networks may also be used as the network 2.

The information processing device 3 is an information processing device according to the present embodiment, and is a movable apparatus that moves autonomously based on map data. The information processing device 3 is also connected to other devices via the network 2, can transmit and receive control signals and data.

The movable apparatus 4 is a movable apparatus configured with the same device as the information processing device 3. The movable apparatus 4 also functions as the information processing device. In other words, the movable apparatus 4 is also the information processing device according to the present embodiment. Both the information processing device 3 and the movable apparatus 4 are movable apparatuses in which events such as a collision may occur.

The surveillance camera 5 is composed of an imaging unit including a lens and an image sensor, and a communication unit, and transmits captured video footage to other devices via the network 2.

The information processing device 3 has a CPU 31, an ROM 32, an RAM 33, a secondary storage unit 34, a communication unit 35, a drive unit 36, a sensor unit 37, and a connection bus 38.

The CPU 31 controls the entire information processing device by executing control programs stored in the ROM 32 and the RAM 33. CPU stands for “Central Processing Unit.”

The ROM 32 is a non-volatile memory that stores the control programs and various data. ROM stands for “Read Only Memory.” The RAM 33 is a volatile memory that functions as a main memory for temporarily storing the control programs and data. RAM stands for “Random Access Memory.”

The secondary storage unit 34 is a rewritable secondary storage device such as a hard disk or flash memory, and stores data received via the communication unit 35. The secondary storage unit 34 also stores control programs, various data, and the results of processing by the CPU 31.

The communication unit 35 is a wireless communication unit and communicates with various devices. The communication unit 35 may be a wired communication unit.

The drive unit 36 is a drive device composed of wheels, motors, actuators, etc. necessary for the movement of the information processing device 3, which is a movable apparatus, and drives the information processing device 3 in accordance with instructions from the CPU 31.

The sensor unit 37 may be a various type of sensors. In the present embodiment, the sensor unit 37 is composed of a LiDAR, an imaging sensor that captures visible light images, and an acceleration sensor that measures acceleration.

LiDAR as the sensor unit 37 stands for “Light Detection and Ranging.” LiDAR is a sensor for measuring map data composed of a point cloud in three-dimensional space, which is necessary for a movable apparatus to enable autonomous moving.

The sensor unit 37 may also be at least one of a ToF sensor, a stereo camera, and a depth camera. The sensor unit 37 may also be a sensor that does not perform three-dimensional measurements but simply detects objects around the movable apparatus, such as an infrared sensor. ToF stands for “Time of Flight.”

The imaging sensor serving as the sensor unit 37 is an image sensor for capturing video footage of the surroundings while information processing device 3 is traveling.

The acceleration sensor serving as sensor unit 37 is a sensor that measures the acceleration in the traveling direction of information processing device 3, which is the movable apparatus. The information processing device 3 uses the sensor unit 37 to detect events such as collisions by determining whether acceleration is normal or abnormal.

The sensor unit 37 may be a sensor other than an acceleration sensor as long as it can detect an event. For example, a sensor that monitors the rotation speed of a wheel or motor of a drive device as the drive unit 36 may be used as the sensor unit 37, and an abnormality in the rotation speed may be detected as an event.

Furthermore, a sensor that measures the remaining battery power required for driving may be used as the sensor unit 37, and a state in which driving ability is lost may be detected as an event.

The connection bus 38 is a connection bus that connects each device that constitutes the information processing device 3 and performs data communication therebetween.

The movable apparatus 4 has a CPU 41, an ROM 42, an RAM 43, a secondary memory unit 44, a communication unit 45, a drive unit 46, a sensor unit 47, and a connection bus 48. Since each unit that constitutes the movable apparatus 4 is similar to that of the information processing device 3, a description thereof will be omitted.

In the present embodiment, the processing described below is implemented in software using the CPU of each device; however, some or all of the processing may also be implemented in hardware. The hardware can be dedicated circuits (ASIC) or other processors (e.g. reconfigurable processors, DSP).

ASIC stands for “Application Specific Integrated Circuit.” DSP stands for “Digital Signal Processor.”

The functional configuration according to the present embodiment is divided into two parts: one related to information processing device 3 that receives event information and performs post-processing, and the other related to movable apparatus 4 that detects an event and transmits the event information to other devices.

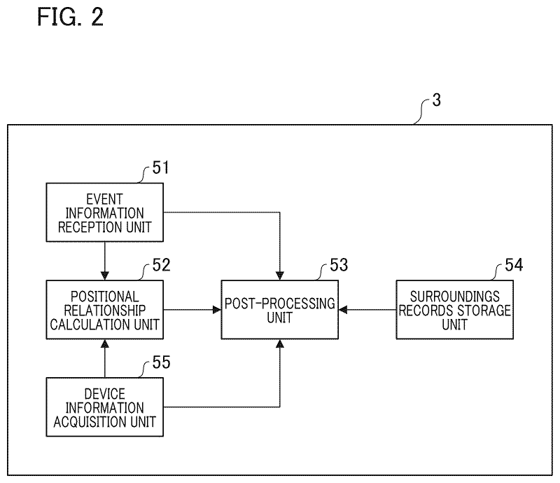

First, the functional configuration related to the information processing device 3 that receives event information and performs post-processing will be described using the block diagram shown in FIG. 2. FIG. 2 is a block diagram illustrating one example of a functional configuration of the information processing device 3 according to the first embodiment of the present disclosure. The information processing device 3 has an event information reception unit 51, a positional relationship calculation unit 52, a post-processing unit 53, a surroundings records storage unit 54, and a device information acquisition unit 55.

The event information reception unit 51 receives event information from other movable apparatuses, and outputs the received event information to the positional relationship calculation unit 52 or the post-processing unit 53.

The positional relationship calculation unit 52 calculates a positional relationship between the event and the device based on the event information acquired from the event information reception unit 51 and the device information acquired from the device information acquisition unit 55. The positional relationship calculation unit 52 outputs the calculated positional relationship to the post-processing unit 53.

The post-processing unit 53 determines and executes the contents of post-processing based on the event information from the event information reception unit 51, the positional relationship from the positional relationship calculation unit 52, the device information from the device information acquisition unit 55, and the surroundings records obtained from the surroundings records storage unit 54.

The surroundings records storage unit 54 stores surroundings records during driving in the secondary storage unit 34 and outputs them to the post-processing unit 53 upon request. In the present embodiment, the surroundings records is video footage captured using the sensor unit 37.

The device information acquisition unit 55 acquires specification information such as the width, height, and weight of the information processing device 3 itself stored in the secondary storage unit 34, and location information of the information processing device 3. The device information acquisition unit 55 outputs the acquired specification information and location information as movable apparatus information to the positional relationship calculation unit 52 or the post-processing unit 53. The location information is estimated based on a map measured by the sensor unit 37.

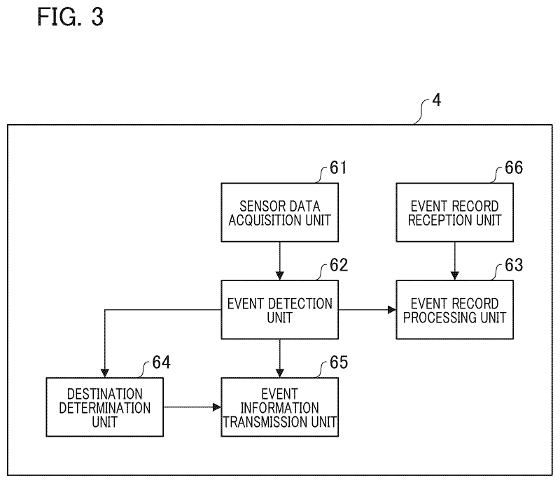

Next, the functional configuration of the movable apparatus 4 that detects an event and transmits event information to another device will be described with reference to the block diagram shown in FIG. 3. FIG. 3 is a block diagram illustrating one example of a configuration of the movable apparatus 4 according to the first embodiment of the present disclosure.

The movable apparatus 4 has a sensor data acquisition unit 61, an event detection unit 62, an event record processing unit 63, a destination determination unit 64, an event information transmission unit 65, and an event record reception unit 66.

The sensor data acquisition unit 61 acquires measurement data from the acceleration sensor of the sensor unit 47 as the sensor information and outputs it to the event detection unit 62.

The event detection unit 62 detects the event based on the measurement data acquired from the sensor data acquisition unit 61, and creates event information for the detected event. The event detection unit 62 outputs the created event information to the destination determination unit 64 or the event information transmission unit 65.

The event record processing unit 63 links the event information obtained from the event detection unit 62 with the event record information, i.e. the event record, obtained from the event record reception unit 66 and stores them in the secondary memory unit 44.

The destination determination unit 64 determines the destination of the device to which the event information obtained from the event detection unit 62 is to be transmitted. The destination determination unit 64 outputs the determined destination to the event information transmission unit 65.

The event information transmission unit 65 transmits the event information obtained from the event detection unit 62 to the destination obtained from the destination determination unit 64. In the present embodiment, the event information transmission unit 65 transmits the event information to the information processing device 3.

The event record reception unit 66 receives the event record via the communication unit 45 and outputs it to the event record processing unit 63.

### [Processing Flow]

### (Processing for Receiving Event Information and Performing Post-processing)

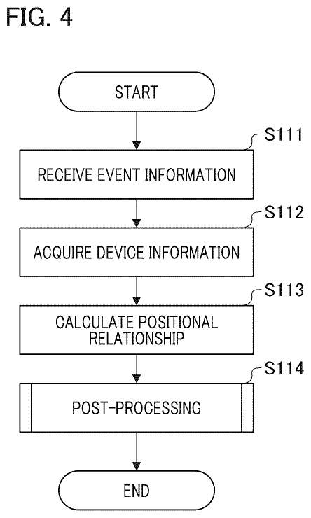

FIG. 4 is a diagram illustrating showing a processing flow in which the information processing device 3 receives event information and performs post-processing according to the first embodiment of the present disclosure. The specific processing will be explained with reference to the diagram.

Note that before this processing flow starts, the information processing device 3 is assumed to be operating to perform tasks such as its own movement and transporting items. Furthermore, while in operation, the information processing device 3 is assumed to be operating while estimating its own position on the map using map data measured by the LiDAR of the sensor unit 37.

Further, while the information processing device 3 is operating, it uses the imaging sensor of the sensor unit 37 to capture video footage as a record of when the movable apparatus is traveling, and continues to record the video footage in the secondary storage unit 34. The information processing device 3 records the video footage in association with the time the video footage was captured, so that the video footage can be retrieved for later based on the time the video footage was captured.

Moreover, while the information processing device 3 is operating, it periodically communicates with surrounding movable apparatuses (in the present embodiment, movable apparatus 4) within the range of wireless communication, and this processing flow starts as a trigger when it receives event information from a surrounding movable apparatus that is traveling autonomously.

First, in step S111, the event information reception unit 51 receives event information from the movable apparatus 4. The event information includes information on the time and location at which the event occurred, as well as specification information such as the width, height and weight of the movable apparatus where the event occurred. An event in the present embodiment is a collision accident in which the movable apparatus collides with another body and stops.

Next, in step S112, the device information acquisition unit 55 acquires device information. Device information is specification information such as the location information, size, weight, type of installed sensor, and sensor resolution and resolution of the device operating in this system.

The specification information may be stored in advance in the secondary storage unit 34. As described above, the location information may be obtained by acquiring the coordinates on a map of the self-location estimated by the sensor unit 37. In the present embodiment, the information processing device 3, which is a movable apparatus, acquires its own device information.

Next, in step S113, the positional relationship calculation unit 52 calculates a positional relationship between the location where the event has occurred and its own position based on the event information and the device information. The positional relationship here refers to a distance from its own position to the location where the event occurred.

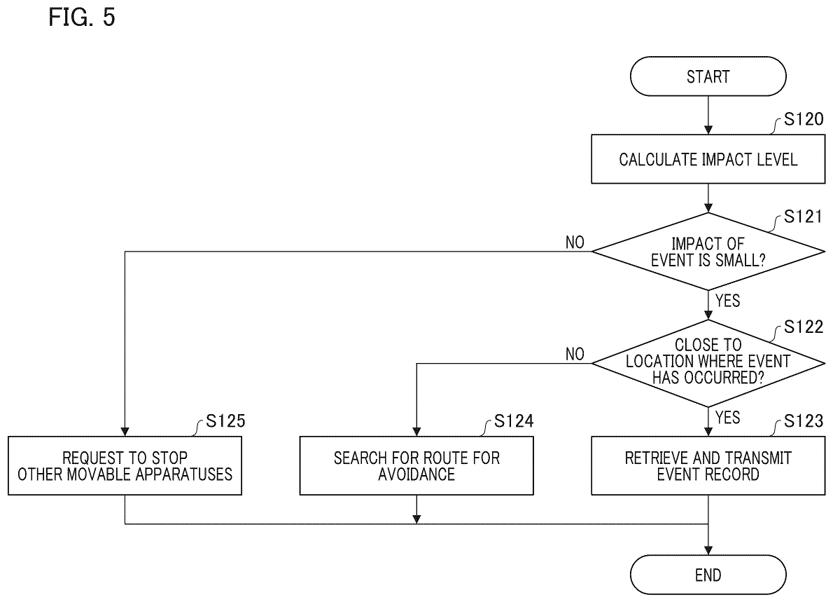

Next, in step S114, the post-processing unit 53 performs post-processing. Details of the post-processing are shown in the processing flow in FIG. 5. FIG. 5 is a diagram illustrating a processing flow of the post-processing executed in step S114 in FIG. 4. Specific steps of the post-processing will be described below with reference to FIG. 5. All of the processes in the flow diagram in FIG. 5 are performed by the post-processing unit 53.

First, in step S120, the post-processing unit 53 calculates an impact level of the event based on the event information and the positional relationship. The impact level is a value indicating the degree of impact on movable apparatuses operating on the system and on the system as a whole.

In the present embodiment, the impact level is divided into two categories: “large” and “small.” For example, if an accident makes it impossible to pass through an aisle, the impact level is determined to be “large.” To make this determination, the ratio of the road width on the map to the width of the vehicle body is calculated, and if it is above a certain ratio, it is calculated that the passage is impossible, in other words, the impact level is large.

In this way, the impact level indicates the size of the range of impacts caused by the event. In other words, if an accident makes a passageway impassable, many movable apparatuses will be affected, and the range of impacts will be large. Conversely, if the accident is minor, only the movable apparatus that caused the accident will be affected, and other movable apparatuses will be able to perform their tasks without any problems, so the range of affected moving bodies, or the range of impacts, will be smaller.

In addition, the impact level may be determined based on the conditions at the location where the event has occurred. For example, if there are many movable apparatuses traveling around the area where the accident has occurred, the space can be determined to be a major passageway, and the impact will be determined to be large.

To determine whether a large number of movable apparatuses are traveling, a movable apparatus that receives the event information (the information processing device 3 in the present embodiment) can communicate with other movable apparatuses to obtain their locations. The impact level may be an integer or a real value within a predetermined range.

In step S121, the post-processing unit 53 determines whether the impact of the event is small. If the post-processing unit 53 determines in step S121 that the impact of the event is small (the impact level is “small”), it executes the processing of step S122. If the post-processing unit 53 determines in step S121 that the impact of the event is not small, i.e. large (the impact level is “large”), it executes the processing of step S125.

If the post-processing unit 53 determines that the impact level is “large,” in step S125 it requests the server 1 to stop other movable apparatuses operating in this system. In response to this request, the server 1 issues an instruction to the movable apparatuses to stop moving.

The instruction from the server 1 to the movable apparatus does not have to be to stop movement, but may be another instruction such as slowing down or retreating to a specified location. When the impact level, which will be described later, is “small,” the post-processing is performed only by the information processing device 3 itself, but when the impact level is “large,” the scope of the post-processing is expanded by requesting other devices to perform the process.

In this way, when the impact level, i.e. the range of impact, is large, the range of post-processing can be expanded accordingly, allowing appropriate post-processing in the case of a major accident. If it is determined that automatic processing by the information processing device 3 is difficult, processing such as calling a worker to deal with the situation may be performed. This processing flow ends after step S125.

If the post-processing unit 53 determines that the impact level is “small,” in step S122, it compares the event information with the device information to determine whether the information processing device 3 was traveling near the location where the event has occurred at the time the event has occurred.

Specifically, the location of the information processing device 3 at the time the event has occurred is obtained from the driving record, and if it is within a predetermined range from the location where the event has occurred, it is determined that the information processing device 3 is close to the location where the event has occurred.

If the post-processing unit 53 determines in step S122 that the information processing device 3 is close to the location where the event has occurred, it executes processing of step S123. If the post-processing unit 53 determines in step S121 that the information processing device 3 is not close to the location where the event has occurred, it executes processing of step S124.

If the post-processing unit 53 determines that the information processing device 3 is close to the location where the event has occurred, in step S123, it retrieves an event record among the surroundings records and transmits the retrieved results to the movable apparatus 4 that is the party involved in the accident. In the present embodiment, the event record is video footage captured by the information processing device 3 while it was traveling.

In step S123, the post-processing unit 53 searches for video footage around the time when the accident has occurred. In step S123, if any relevant video footage is found, the post-processing unit 53 transmits the video footage to the movable apparatus 4.

In step S123, the post-processing unit 53 transmits a message to the movable apparatus 4 if there is no corresponding video footage. Video footage captured at the time the event occurred by a movable apparatus traveling nearby is likely to contain a scene of the event. For this reason, the information processing device 3 transmits the video footage captured at the time when the event has occurred as an event record.

The information processing device 3 may check whether the video footage indeed includes a scene of the event. In this case, for example, the event (in the present embodiment, a collision accident) may be detected from the video footage using image recognition.

Further, a two-dimensional barcode or number for identifying the individual movable apparatus may be written on the body of the movable apparatus, and the information processing device 3 may read this from the captured video footage to identify the individual body and confirm whether it was the body involved in the accident.

In this way, the information processing device 3 can transmit the relevant video footage that is the retrieved result to the movable apparatus 4 that caused the accident, so that the recorded video footage can be collected on the movable apparatus 4 involved in the accident. This makes it easy to retrieve the record of the event when it is desired to refer to it later.

On the other hand, if the post-processing unit 53 determines that the information processing device 3 is not near the location where the event has occurred, then in step S124, it is assumed that the information processing device 3 does not hold the event record, and therefore does not retrieve or transmit the event record, but instead performs a different post-processing.

In this case, since the information processing device 3 is considered to be located at a certain distance from the accident site, it searches for an avoidance route and corrects the driving route so as not to pass through the accident site.

Specifically, the information processing device 3 refers to its own driving plan and changes the planned route so as to avoid the location where the event has occurred. A driving plan is information that describes the planned driving route on the map data and indicates the route along which the movable apparatus is planned to travel.

If the driving plan does not include a plan to pass near the location where the event has occurred, the information processing device 3 does not change the driving plan. Furthermore, if a driving route that avoids the accident site cannot be found, the information processing device 3 selects a driving route that is as far away from the location where the event has occurred as possible.

If such a route cannot be found, the information processing device 3 does not modify the original driving plan. In this way, a driving route that can further reduce the impact of the event can be selected.

In the present embodiment, whether or not the event record is stored is determined based on whether or not the movable apparatus was near the location where the event has occurred at the time the event has occurred, but other methods may be adopted. For example, in addition to whether the movable apparatus was driving near the location where the event has occurred described above, whether or not the imaging device was facing the location where the event has occurred may also be determined. It is possible to make determination that the imaging device was facing the location where the event has occurred if such a location is included within a pre-defined angle range relative to the camera orientation.

Furthermore, in the present embodiment, video footage captured by the imaging device is transmitted as the event record, but other information may also be transmitted. For example, the information processing device 3 may be equipped with a device such as a microphone so that audio can be transmitted as the event record.

### (Processing of Movable Apparatus for Transmitting Detected Event Information)

Up to this point, the information processing device 3 that receives event information and performs post-processing has been explained. The movable apparatus that transmits the event information (movable apparatus 4 in the present embodiment) will be described hereinbelow.

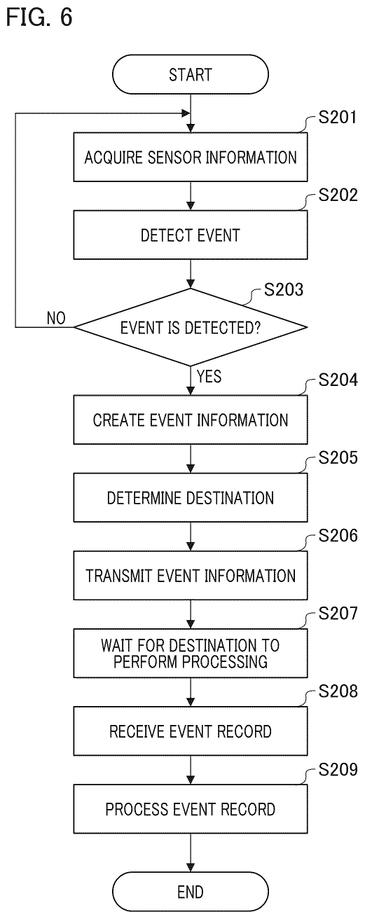

FIG. 6 is a diagram illustrating a processing flow for the movable apparatus 4 to detect an event that has occurred and transmit event information in the present embodiment. The detailed process will be explained with reference to this flow diagram.

It is assumed that the processing of this flow starts in the background when movable apparatus 4 begins operating. The movable apparatus 4 is assumed to be traveling autonomously in order to execute a task as a self-driving movable apparatus separate from this flow, i.e. a task such as transporting items. This allows it to detect events that occur during operation in real time and carry out subsequent processing.

First, in step S201, the sensor data acquisition unit 61 acquires sensor information. As described above, the sensor data acquisition unit 61 acquires acceleration data from the acceleration sensor.

Next, in step S202, the event detection unit 62 detects an event by detecting an abnormal value in the measurement data of the acceleration sensor. In the present embodiment, a collision is detected as an event, so it is sufficient to detect a change in the acceleration data.

Specifically, the event detection unit 62 retains the acceleration data acquired last time, calculates a difference between the acceleration data acquired this time, and determines that an event (collision) has occurred if the difference is greater than a predetermined threshold.

The event detection unit 62 may make a judgment using the acceleration data in multiple directions, such as acceleration in the direction of travel and acceleration in other directions. In this way, the event detection unit 62 detects the occurrence of an event during self-driving.

In the present disclosure, the method of detecting an event is not limited to the above-mentioned method. It is also possible to determine that an abnormality has occurred and detect a collision if the change in speed over a specified period of time is greater than a predefined value based on speed data instead of acceleration.

In addition, events other than collisions may be detected. For example, a failure of a device or part that makes up the movable apparatus may be detected as an event. A sensor may be attached to measure the rotation speed and current of the motor in the drive unit, and if any of the values fall outside a predetermined normal range, it may be determined that a failure has occurred, i.e. that an event has occurred.

If the event detection unit 62 determines in step S203 that an event has been detected, it executes the process of step S204, and if it determines that an event has not been detected, it returns to step S201 and continues processing. In step S204, the event detection unit 62 creates event information for the detected event.

In step S205, the destination determination unit 64 determines to which device the event information created in step S204 should be transmitted. In the present embodiment, the event information is transmitted to all devices within a distance range where wireless communication is possible from the movable apparatus 4.

Here, it is assumed that the information processing device 3 is traveling within a distance range where wireless communication is possible from the movable apparatus 4, and the information processing device 3 is determined as the destination. In this way, the destination can be quickly determined with minimal communication, and the event information can be transmitted quickly.

Other methods for determining the destination may also be used. The destination may be determined by obtaining location information from a device with which communication is possible, calculating the distance from its own location, and then determining the destination. Although this requires more effort to measure the positional relationship, it allows event information to be transmitted only to devices that are close in distance, so there is less wasted communication traffic.

Next, in step S206, the event information transmission unit 65 transmits the event information to the information processing device 3 determined as the destination in step S205.

Next, in step S207, the event record reception unit 66 waits for the destination, i.e. information processing device 3, to which the event information was transmitted in step S206 to perform post-processing in accordance with the event information and transmit the processing results. As described above, the information processing device 3 determines and executes the content of the post-processing in accordance with the transmitted event information, and then transmits the execution result to the sender of the event information, that is, in this case, the movable apparatus 4.

Next, in step S208, the event record reception unit 66 receives the event record from the information processing device 3. The event record is information that records an event or serves as evidence, and in the present embodiment is video footage of the time the accident occurred. It may also be audio information, distance measurement data from a distance sensor, or other data.

Next, in step S208, the event record processing unit 63 performs processing corresponding to the received event record. In this case, video footage of the collision accident has been received as the event record, so the received video footage is stored in association with the event information.

Storing the video footage in this way makes it easy to search for evidence of an accident later. As mentioned above, event information contains information such as the type of event, the location where it has occurred, and the date and time it has occurred, so by using these as search keys, a user can easily retrieve the desired event record.

Further, because the video footage is stored in the vehicle that caused the accident, the effort of searching for the stored vehicle is saved. In other words, because event information and event records are consolidated and stored in a single device, the effort of searching for desired information is saved.

This concludes the description of the first embodiment of the present disclosure. As described above, according to the present embodiment, a self-driving movable apparatus detects an event and transmits event information to other movable apparatuses, making it possible to automatically handle post-event responses, which is highly convenient.

Furthermore, with post-event response according to the impact of the event, i.e. the scope of the impact, post-event processing can be done according to the status of the event and the movable apparatus, rather than a uniform standard. This allows for more appropriate post-event processing, improving the usability of the system.

### Modified Example 1-1

In the first embodiment, the method of post-processing was described as a process of retrieving whether the information processing device 3 has an event record, but other post-processing may also be employed. Here, an example of another post-processing will be described as Modified Example 1-1.

For example, if a movable apparatus is located within a specified range from the location where the event has occurred, the movable apparatus can be directed to the location where the event has occurred to capture video footage after the event occurred.

In this way, even if there is no video footage remaining at the time the event has occurred, it is possible to capture video footage after the event as a second-best option, and to leave useful information as a record of the accident.

### Modified Example 1-2

In the first embodiment, the information processing device 3, i.e. the movable apparatus, performed the post-processing, but other devices may also perform the same. Here, as Modified Example 1-2, an example of post-processing performed by other devices will be given. For example, the surveillance camera 5 may perform the post-processing.

Similar to when a movable apparatus performs post-processing, the surveillance camera 5 close to the location where the event has occurred can search its own storage for video footage showing the event. Further, as shown in Modified Example 1-1, the surveillance camera 5 can be configured to capture post-event video footage.

Moreover, by placing multiple surveillance cameras 5 in multiple locations and setting the area that each surveillance camera will capture, it can be determined which surveillance camera will capture the event depending on the location where the event has occurred.

### Modified Example 1-3

In the first embodiment, the example of the event record process performed by the movable apparatus 4 is described in which the received video footage is recorded, but other processes may also be performed. Here, an example of other processes is given as Modified Example 1-3.

For example, the movable apparatus 4 may perform a recovery operation to return to a normal state from a contact state caused by an accident based on the received event record. Specifically, the movable apparatus 4 analyzes, based on the received video footage of the accident, in which direction it should move to resolve the contact state, and controls itself accordingly.

The movable apparatus 4 may also use map data for analysis to determine in which direction it should move from its own perspective. The event record processing unit 63 performs at least one of a process of storing the event record and a process of recovering from the event based on the event record.

### Second Embodiment

In the first embodiment, the movable apparatus 4 transmitted event information to the movable apparatus (information processing device 3). In the second embodiment, an example will be described in which the movable apparatus 4 transmits event information to the server 1, and the server 1 performs post-event processing.

That is, in the second embodiment, the server 1 performs the function of the information processing device 3 in the first embodiment. In other words, the server 1 is the information processing device according to the present embodiment. The movable apparatus 4 that detects an event transmits event information to the server 1 where information on each operating movable apparatus is aggregated, making it possible to perform post-event processing according to the status of the multiple movable apparatuses. In order to avoid redundancy, a description of processing similar to that of the first embodiment will be omitted.

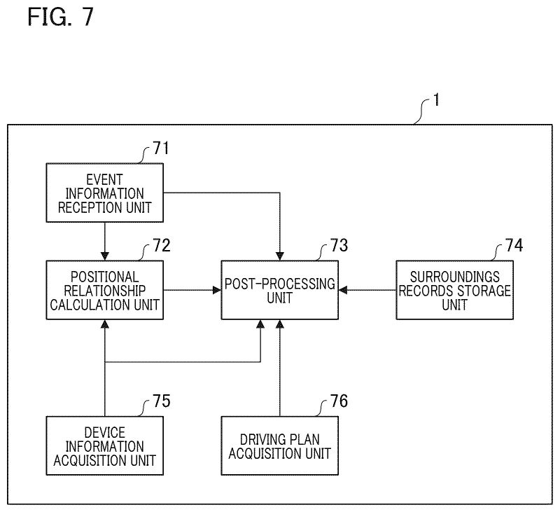

FIG. 7 is a block diagram illustrating one example of a configuration of the server 1 according to the second embodiment of the present disclosure. The server 1 has an event information reception unit 71, a positional relationship calculation unit 72, a post-processing unit 73, a surroundings records storage unit 74, a device information acquisition unit 75, and a driving plan acquisition unit 76.

The event information reception unit 71 is similar to the event information reception unit 51 in the first embodiment, so its description will be omitted. The positional relationship calculation unit 72 is similar to the positional relationship calculation unit 52 in the first embodiment, so its description will be omitted. The post-processing unit 73 is similar to the post-processing unit 53 in the first embodiment, so its description will be omitted.

The surroundings records storage unit 74 retains video footages captured by the information processing device 3, the movable apparatus 4, and the surveillance camera 5, and outputs them to the post-processing unit 73 as necessary.

The device information acquisition unit 75 acquires device information of devices including the movable apparatus stored in the server 1, and outputs it to the post-processing unit 73.

The driving plan acquisition unit 76 acquires the driving plan of the movable apparatus stored in the server 1 and outputs it to the post-processing unit 73.

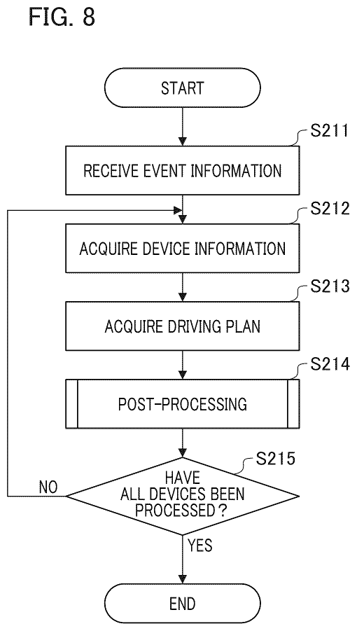

FIG. 8 is a diagram illustrating a processing flow in which the server 1 receives event information and performs post-processing according to the second embodiment of the present disclosure. The specific processing will be explained with reference to FIG. 8. In the second embodiment, as in the first embodiment, it is assumed that the server 1 and the movable apparatus 4 are operating at the time this flow starts, and the preparations necessary for executing this flow have been completed.

Step S211 is similar to step S111 in the first embodiment. That is, in step S211, the event information reception unit 71 receives event information from the movable apparatus 4.

Next, in step S212, the device information acquisition unit 75 acquires one piece of device information for which processing has not yet been completed from the device information in the system. In the present embodiment, one piece of device information is acquired from the information processing device 3 (movable apparatus), movable apparatus 4, and surveillance camera 5 shown in FIG. 1.

The device information records information on the location of each device. Each device transmits its device information to the server 1 at regular intervals, allowing the server 1 to know the current location of each device. Even for devices that do not move autonomously, such as the surveillance cameras 5, it is preferable to regularly update the location information, as there is a possibility that they may be moved manually.

Next, in step S213, the driving plan acquisition unit 76 acquires driving plans for the movable apparatuses in the system. A driving plan is route information on a map along which the movable apparatuses are scheduled to move, and each movable apparatus moves autonomously based on its own driving plan.

Next, in step S214, the post-processing unit 73 performs post-processing. Details of the post-processing in step S214 will be described later.

Next, in step S215, the post-processing unit 73 determines whether all devices have been processed. If all devices have been processed, the processing ends, and if there are any other devices that have not been processed, the processing returns to step S212 and continues.

Hereinbelow, the contents of the post-processing in step S214 will be explained with reference to FIG. 5, as in the first embodiment. Note that in the second embodiment, all of the processing in the flow chart of FIG. 5 is performed by post-processing unit 73.

First, in step S120, the post-processing unit 73 calculates the impact of the event based on the event information and the driving plans of multiple movable apparatuses. Specifically, the post-processing unit 73 counts the number of movable apparatuses that are planned to travel through the event occurrence location, and if the counted number is greater than a predetermined threshold, the impact level is set to “large.”

Furthermore, if the counted number is not greater than a predetermined threshold, the post-processing unit 73 determines the impact level to be “small.” If an accident occurs in an area where many movable apparatuses are scheduled to travel, many movable apparatuses will be affected.

In some cases, it may become impossible to pass through, so the occurrence of an event in such a place can be said to have a high impact level. As mentioned above, the impact level refers to the size of the affected area.

In step S121, the post-processing unit 73 determines whether the impact of the event is small. If the post-processing unit 73 determines in step S121 that the impact of the event is small (the impact level is “small”), it executes the processing of step S122.

If the post-processing unit 53 determines in step S121 that the impact of the event is not small, i.e. large (the impact level is “large”), it executes the processing of step S125.

If the post-processing unit 73 determines that the impact level is “large,” then in step S125 it issues an instruction to the target device to stop moving, and ends this flow. Even if there are movable apparatuses that have been instructed to perform other processing at this point, each movable apparatus will prioritize the stop processing instructed by the server 1 to stop moving in step S125.

If the post-processing unit 73 determines that the impact level is “small,” in step S122, it compares the event information with the device information to determine whether the target device was traveling near the location where the event has occurred at the time the event has occurred.

If the post-processing unit 73 determines in step S122 that the target device is close to the location where the event has occurred, it executes processing of step S123. If the post-processing unit 73 determines in step S121 that the target device is not close to the location where the event has occurred, it executes processing of step S124.

If the post-processing unit 73 determines that the target device is close to the location where the event has occurred, in step S123, it instructs the target device to retrieve the event record and transmit the retrieved results to the server 1, and ends this flow. The other processing contents of step S123 are the same as in the first embodiment, so a description thereof will be omitted.

If the post-processing unit 73 determines that the target device is not close to the location where the event has occurred, then in step S124, the post-processing unit 73 searches for a driving route for the target device that does not pass through the location where the event occurred.

At this time, the server 1 holds the driving plans of all movable apparatuses, so by selecting a route not only to avoid the location where the event has occurred, but also as a route with few other movable apparatuses scheduled to travel, it is possible to avoid congestion and traffic jams caused by moving objects concentrating in one location or passageway. After this processing, this flow ends.

This concludes the description of the second embodiment. According to the second embodiment, as described above, by transmitting the event information to the server 1, post-processing can be performed taking into account multiple movable apparatuses operating on the system.

In the second embodiment, the processing load on the server 1 is greater than in the first embodiment in which devices communicate with each other to perform post-processing, but the processing load can be reduced because the movable apparatuses do not determine their own post-processing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the information processing device and so on through a network or various storage media. Then, a computer (or a CPU, an MPU, or the like) of the information processing device and so on may be configured to read and execute the program. In such a case, the program and the storage medium storing the program configure the present invention.

In addition, the present disclosure includes those realized using at least one processor or circuit configured to perform functions of the embodiments explained above. For example, a plurality of processors may be used for distribution processing to perform functions of the embodiments explained above.

What is claimed is:

1. An information processing device, comprising:
at least one processor or circuit configured to function as:
an event information reception unit configured to receive event information of an event that occurs in an autonomous movable apparatus;
a device information acquisition unit configured to acquire device information of a device other than the movable apparatus in which the event has occurred; and
a post-processing unit configured to perform post-processing after the event has occurred based on the event information and device information.

2. The information processing device according to claim 1, wherein the event information includes information on the location where the event has occurred,
the device information includes information on a position of the device,
the information processing device further comprises a positional relationship calculation unit configured to calculate a positional relationship between the location where the event has occurred and the position of the device, and
the post-processing unit is configured to perform post-processing in accordance with the positional relationship.

3. The information processing device according to claim 2, further comprising:
a surroundings records storage unit configured to store surroundings records of the surroundings of the device,
wherein the post-processing unit is configured to retrieve the surroundings records for an event record of the event and transmits the search results to the movable apparatus in which the event has occurred.

4. The information processing device according to claim 1, wherein the post-processing unit is configured to capture video footage including the location where the event has occurred after the event has occurred based on the event information received by the event information reception unit, and transmit the video footage to the movable apparatus where the event has occurred.

5. The information processing device according to claim 1, wherein the post-processing unit is configured to set a driving route based on the event information and the device information so as not to pass through the location where the event has occurred.

6. The information processing device according to claim 1, wherein the post-processing unit is configured to expand a scope of the post-processing depending on the range of the event impact.

7. The information processing device according to claim 6, further comprising:
a driving plan acquisition unit configured to acquire a driving plan for a plurality of movable apparatuses,
wherein the post-processing unit is configured to expand the scope of post-processing depending on the number of movable apparatuses that are planned to pass through the location where the event has occurred based on the event information and the driving plan.

8. An information processing device, comprising:
a sensor data acquisition unit configured to acquire sensor information;
an event detection unit configured to detect that an event has occurred during self-driving based on the sensor information, and create event information including information on a location where the event has occurred;
a destination determination unit configured to determine a device to which the event information is to be sent; and
an event information transmission unit configured to transmit the event information to the destination,
wherein the destination determination unit is configured to determine the destination based on a positional relationship between the location where the event has occurred and the device.

9. The information processing device according to claim 8, further comprising:
an event record reception unit configured to receive an event record from a device to which the event information transmission unit has transmitted the event information; and
an event record processing unit configured to perform at least one of a process of storing the event record and a process of recovering from the event based on the event record.

10. The information processing device according to claim 1, wherein the event is a collision accident in which a movable apparatus comes into contact with another body.

11. The information processing device according to claim 1, wherein the event is a failure of a device constituting a movable apparatus.

12. The information processing device according to claim 1, wherein the event is a loss of driving ability of a movable apparatus.

13. A control method for an information processing device, the method comprising:
an event information reception step of receiving event information of an event that occurs in an autonomous movable apparatus;
a device information acquisition step of acquiring device information of a device other than the movable apparatus in which the event has occurred; and
a post-processing step of performing post-processing after the event has occurred based on the event information and device information.

14. A control method for an information processing device, the method comprising:
a sensor data acquisition step of acquiring sensor information;
an event detection step of detecting that an event has occurred during self-driving based on the sensor information, and creating event information including information on a location where the event has occurred;
a destination determination step of determining a device to which the event information is to be sent; and
an event information transmission step of transmitting the event information to the destination,
wherein the destination determination step is to determine the destination based on a positional relationship between the location where the event has occurred and the device.

15. A storage medium for storing a computer program to allow a computer to execute:
a sensor data acquisition step of acquiring sensor information;
an event detection step of detecting that an event has occurred during self-driving based on the sensor information, and creating event information including information on a location where the event has occurred;
a destination determination step of determining a device to which the event information is to be sent; and
an event information transmission step of transmitting the event information to the destination,
wherein the destination determination step is to determine the destination based on a positional relationship between the location where the event has occurred and the device.
